(19) United States
(12) Patent Application Publication
(10) Pub. No.: US 2024/0188538 A1
(43) Pub. Date: Jun. 13, 2024

(54) Dog Boot

(71) Applicant: Matt Perella, Hendersonville, NC (US)

(72) Inventor: Matt Perella, Hendersonville, NC (US)

(21) Appl. No.: 18/079,180

(22) Filed: Dec. 12, 2022

(51) Int. Cl. A01K 13/00

(52) U.S. Cl. CPC A01K 13/007

(57) ABSTRACT

A dog boot is described for protecting feet of dogs and for other animals with dog foot structure. The dog boot comprises boot cover, non-flat sole, separate paw digits which are not adjoining with one another along their sides, and multiple paw grip pads. Each of the paw digits has a front opening for dog's toe nail to protrude. Because dog's feet are not flat on the bottom of their paws, the boot sole is configured to coordinate with bottom of a dog's paw to keep the dog's foot locked in place. The paw grip pads include four digital paw grip pads and one metacarpal paw grip pad. Each of the paw grip pads is attached to a bottom of the sole separately. The digital paw grip pads are located underneath the individual paw digits while the metacarpal paw grip pad is located at bottom of the boot's heel.

### BACKGROUND

This invention relates to a dog boot and more broadly to a boot for animals, providing protective covers for the animal's paws to allow the animal to perform activities with comfort.

Dogs provide various services for humans, such as companionship, guarding a home, sled towing, hunting, and working as a service, police, or military dog. At various times and for diverse reasons, it may be desirable for a dog's owner to place boots upon the dog's paws. For example, after a long exercise outdoors, the animal may track mud, snow, dirt, and other outdoor contaminants back into the owner's dwelling upon returning from outside. This may require the owner to perform additional cleaning. In another instance, a dog may have injured one or more paws, a suitable boot may help protect the injured paw until the paw or paws are recovered. Yet, in another instance, the dog's own paws may be inadequate for traversing the ground for a long distance when temperatures are severe, such as in colder climates when the ground may be covered by ice shards as well as being cold, or when the temperatures are extremely hot such that the ground may be scorching. The dog boots can be used to protect dog's paws and to provide traction on the ground in such conditions.

A number of dog shoes and boots are in the market. However, these dog shoes and boots tend to suffer from a few limitations. One of the limitations is that the dog shoes or boots fully enclose dog's paws therein, including claws, thereby restricting the dog's paw functionality and even causing loss of traction on the ground. Another limitation is that some dog shoes or boots tend to slip off readily from the dog during an ordinary movement. Furthermore, another limitation is that the dog shoes or boots have flat soles, causing the dog's foot to slide around inside the boot, potentially resulting in the bottoms of the dog's paws becoming rubbed raw when the dog is running in a long-distance trail run.

### BRIEF SUMMARY OF THE INVENTION

An object of embodiments of the present invention is to provide a dog boot for dogs engaged in long-distance trail runs. The dog boot is form-fitted to the dog's foot, providing a protective cover.

Another object of embodiments of the present invention is to provide a dog boot with separate paw digits. Each front of the paw digits has an opening for a toe nail of the dog to protrude out so that the toe nails are not confined within the dog boot.

Yet another object of embodiments of the present invention is to provide a dog boot with a non-flat sole. Unlike flat soles for most of dog shoes or boots in the current market, the sole in exemplary embodiments of the present invention is curved, being configured to coordinate with bottom of a dog's paw. Because dog's feet are not flat, the soles of the dog's boots are shaped like a bottom of the dog's paw according to the embodiments of the present invention.

Still another object of embodiments of the present invention is to provide a dog boot with paw grip pads located separately at bottom of the boot. Different paw grip pads may be made of different materials or made of same material but on the bottom having different engraved patterns selected for desired grip on the ground and flexibility.

Furthermore, another object of embodiments of the present invention is to provide a boot for small animals whose feet have commonalities with dog foot structure. The features of the animal boot are similar to that of the dog boot. Description of embodiments of the invention in relation to the animal boot may be referenced from the descriptions of corresponding parts in the dog boot.

According to embodiments of the present invention, a dog boot comprises a boot cover, a plurality of paw digits, and a sole. The sole includes a sole layer and multiple paw grip pads.

The boot cover includes an upper tubular section and a fastening means. The upper tubular section includes one or more slits for the dog's paw to slide into the shoe easily. The slits extend from a top opening of the upper tubular section downward to divide the tubular section into two upper half sections. In some embodiments, there are two slits in the upper tubular section with one on the left and the other on the right side of the dog's leg. The fastening means secures the two upper half sections wrapped around the dog's leg to prevent the boot from readily slipping off the dog.

The paw digits are configured to receive each of the dog's toes. Each of the paw digits is coupled to the boot cover separately and the paw digits are not adjoining with one another along their sides. As a result, the paw digits are movable relative to one another. Each of the paw digits has a front opening that enables a dog's toe nail to protrude from the boot.

The sole in the embodiments comprises a sole layer and multiple paw grip pads attached to bottom of the sole layer. The sole layer is coupled to the boot cover and coupled to the paw digits, forming a paw receiving space between the boot cover and the sole layer and between the paw digit and the sole layer. The paw receiving space is configured to form-fit a dog's paw. The sole layer is curved to coordinate with bottom of a dog's paw.

The paw grip pads include a plurality of digital paw grip pads and a metacarpal paw grip pad. Each of the digital paw grip pads is attached directly underneath a paw digit, and the metacarpal paw grip pad is located underneath a heel of the boot.

The subject matter of the present invention can be understood by professionals skilled in the art in light of the detailed patent description, the claims, and the drawings of the present invention.

### BRIEF DESCRIPTION OF THE DRAWINGS

The drawings illustrate a right front dog boot. Although not shown in figures, a left front boot would be a mirror image of the right front dog boot. Furthermore, the schematic structures of left rear and right rear dog boots could be referenced from exemplary parts of the right front dog boot.

The following drawings are merely for illustrative purposes according to various embodiments and are not intended to limit the scope of the present invention:

FIG. 1 is a side perspective view showing a dog boot, according to an embodiment of the present invention;

FIG. 2 is a bottom view showing a sole bottom of the dog boot according to an embodiment of the present invention;

FIG. 3 is a left side view showing the right dog boot according to an embodiment of the present invention;

FIG. 4 is a front view showing a front of boot cover and paw digits of the right front boot according to an embodiment of the present invention, also shown is a location cut taken for a sectional view in FIG. 5;

FIG. 5 is a sectional view taken across line 5-5 of a paw digit in FIG. 4;

FIG. 6 is a back side view showing a back of the boot cover and sole of the right front boot according to an embodiment of the present invention; also shown is a location cut taken for a sectional view in FIG. 7;

FIG. 7 is a sectional view taken across line 7-7 of an upper tubular section of the dog boot of FIG. 6.

### DETAILED DESCRIPTION

Reference will be made in detail to exemplary embodiments of the invention, which are illustrated in the accompanying drawings. The advantages, features, and benefits of the present invention will become apparent from the drawings and specifications. In the drawings, wherever possible, the same reference numbers will be used to refer to the same or like parts.

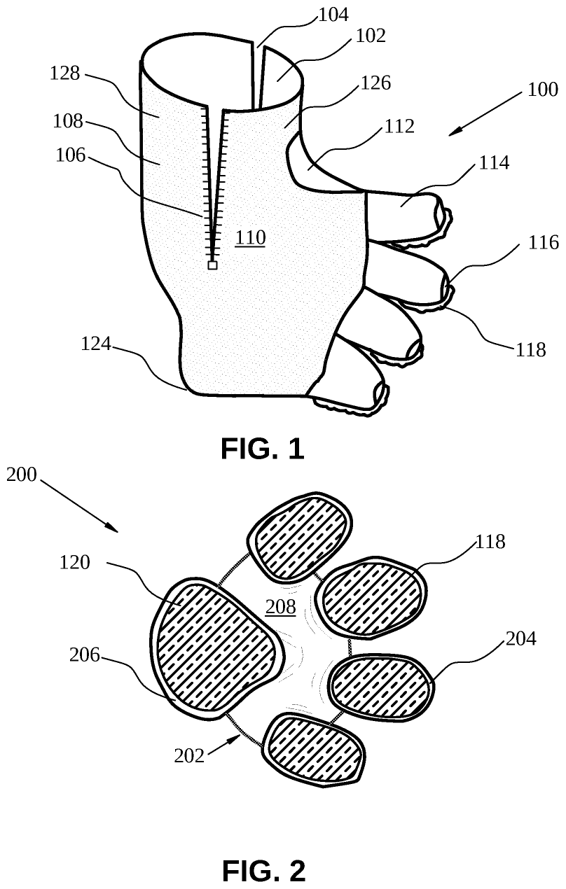

Referring to FIG. 1, there illustrated is a side perspective view of a right front dog boot according to an embodiment of the present invention. A left front dog boot is precisely a mirror image of the right front dog boot. A right rear and left rear dog boots are similar, respectively, to the right front and left front dog boots in structures and parts of making with one exception that there need not be a hole 112 in the rear dog boots for the dogs with no rear due paws. Because most dogs only have front due paws with a few exceptions, such as Great Pyrenees, Saint Bernard, and Briards. Thus, the hole 112 for exposing the front due claw in the front dog boots is not necessary in the rear dog boots for the dogs with only front due paws.

In the embodiment shown in FIG. 1, the dog boot 100 comprises a boot cover 110, the boot cover 110 including an upper tubular section 108, four paw digits 114 coupled to the boot cover 110, a heel 124 of the boot, digital paw grip pads 118, and a hole 112 for exposing a due claw of the paw. There are two slits 104 in the upper tubular section 108 and zippers, functioning as a fastener 106, installed for each slit 104.

The upper tubular section 108 reaches up to an ankle or farther up a leg of the dog. The two slits 104 divide the upper tubular section 108 into two sections, front upper half section 126 and back upper half section 128. The slits 104 make it easy for the dog paw to slide into the boot 100. Each slit 104 has installed a fastener 106, such as a zipper, to secure the tubular section 108 wrapped around the dog's leg. The fastener 106 is selected from a group including zipper, hook with an eyelet and strap, and Velcro. When used as a fastener, the zipper may be shielded by a waterproof cloth. The hook or Velcro is made to be waterproof when used as a fastener for the dog boot according to embodiments of the present invention.

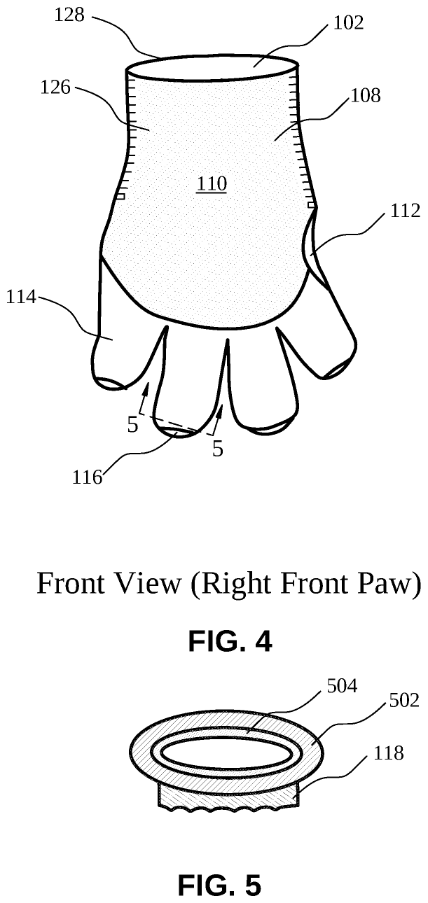

The boot cover 110 and outer layers of four paw digits 114 (see FIG. 4) may be made of different materials. The material for making the boot cover 110 may be a flexible cloth with a fibrous texture while the material for the outer layers of four paw digits 114 is waterproof and durable.

Each of the four paw digits 114 has a front opening 116 for a dog's toe nail to protrude out. Each of the paw digits 114 is coupled to the boot cover 110 separately and the paw digits 114 are not adjoining with one another along their sides. Each paw digit 114 has a digital paw grip pad 118 attached underneath thereof.

Referring to FIG. 2, there illustrated is a bottom view of the dog boot sole 200 according to an embodiment of the present invention. The sole 200 comprises a non-flat sole layer 202 and five paw grip pads attached to the sole layer 202, including four digital paw grip pads 118 and one metacarpal paw grip pad 120. The sole layer 202 consists of multiple sections, including sole layer sections 204 positioned below the paw digits to be coupled with the paw digits thereof, a sole layer section 206 positioned at bottom of the heel 124 of the boot, and a central sole layer section 208 positioned in between to connect with the sole layer sections 204 and sole layer section 206. The digital paw grip pads 118 are attached separately to bottom of the sole layer sections 204 and the metacarpal paw grip pad 120 is attached to bottom of the sole layer section 206. The bottoms of the paw grip pads are patterned, like a bike tire or sole of a human shoe, producing a rugged bottom surface to facilitate dog paw's griping on the ground during running.

Referring again to FIG. 2, the curved sole layer 202 coordinates with bottom of the dog's paw so that the central sole layer section 208 of the sole is elevated from the ground when the dog is running. Because dog's feet are not flat on the bottom of their paws, the boot sole is shaped like a dog's paw to keep the dog's foot locked in place.

Referring to FIGS. 1 and 2, a paw receiving space between the boot cover 110 and the sole layer 202 and between the paw digits 114 and the sole layer 202 is formed by coupling the sole layer sections 206 and 208 with the boot cover 110 and coupling the sole layer sections 204 with the paw digits 114. Each of the digital paw grip pads 118 is attached to a bottom of the sole layer sections 204 underneath one of the paw digits 114. The metacarpal paw grip pad 120 is attached to the sole layer section 206.

The digital paw grip pads 118 and the metacarpal paw grip pad 120 are made of a durable rubber material with high quality.

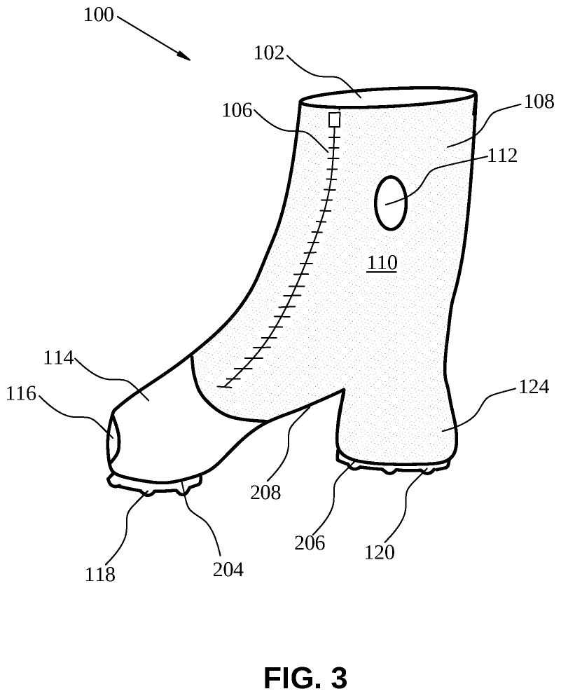

Referring to FIG. 3, there illustrated is a left side view of the right front dog boot 100 according to an embodiment of the present invention. The hole 112 is located above the heel 124 of the dog boot for exposing a due claw. The zipper, functioning as fastener 106, extends from the top opening 102 downward, ending near the paw digit 114. The paw digit 114 has the front opening 116 for the dog's toe nail to protrude out of the boot. The digital paw grip pad 118 underneath the paw digit 114 is attached to the sole layer section 204. The metacarpal paw grip pad 120 underneath the boot heel 124 is attached to the sole layer section 206.

In the embodiment shown in FIG. 3, the sole 200 of the boot 100 is shown with the central sole layer section 208 indented upward. The indentation of the central sole layer section 208 starts from an inner edge of the metacarpal paw grip pad 120 and ends at an inner edge of the digital paw grip pad 118. The central sole layer section 208 coordinates with a bottom of the dog's paw. In some embodiments, the central sole layer section 208 may form-fit bottom of the dog's paw. In some of the other embodiments, the central sole layer section 208 may leave a little room between bottom of the dog's paw and the boot's sole layer 202.

Referring back to FIG. 2, the sole layer 202 is composed of multiple layers. The multiple layers include an inner layer and an outer layer. Also, the paw digits 114 (shown in FIG. 4) are composed of multiple layers, including an inner layer and an outer layer. The outer layer of the sole layer 202 and the outer layers of the paw digits are made of a waterproof material. The outer layer of the sole layer is made entirely of a durable rubber. According to an embodiment of the present invention, the overall sole layer 202 is made to be flexible. According to another embodiment of the present invention, the outer layer of the sole layer 202 and outer layers of paw digits 114 are coupled into an integral one piece.

Referring to FIG. 4, there illustrated is a front view of a boot cover and paw digits of the right front boot according to an embodiment of the present invention. As shown, the paw digits 114 are coupled to the boot cover 110 separately and are not adjoining with one another along their sides so that the paw digits 114 are movable relative to one another. According to the embodiment shown in FIG. 4, the boot cover 110 may be made of a flexible cloth while the outer layers of paw digits 114 are made of a waterproof material.

Referring to FIG. 5, there illustrated is a sectional view taken across line 5-5 of a paw digit in FIG. 4. As shown in FIG. 5, the paw digit 114 comprises an inner layer 504 and an outer layer 502. The inner layers 504 of the paw digits 114, the inner layer of sole 202, and the boot cover 110 may be made of a same flexible cloth material.

According to an embodiment of the present invention, the boot cover 110, the inner layers of paw digits 114, and the inner layer of the sole layer 202 may be made as one integral piece, for example, an integral piece of knitted yarn. In another embodiment, this one integral piece may be assembled with an integral outer layer that includes the outer layer of the sole layer 202 and the outer layers of the paw digits 114 to make a main body of the dog boot. A following attachment of the paw grip pads 118 and 120 to the bottom of the sole layer 202 would complete production of the dog boot.

Yet, according to another embodiment of the present invention, after making an integral piece that comprises the boot cover 100, the inner layers of paw digits 114, and the inner layer of the sole layer 202, outer layers of the paw digits are disposed on the inner layers of the paw digits separately, for example by sewing. Then an outer layer of the sole layer is disposed on the inter layer of the sole layer, joining with outer layers of the paw digits seamlessly so as to prevent water from leaking through.

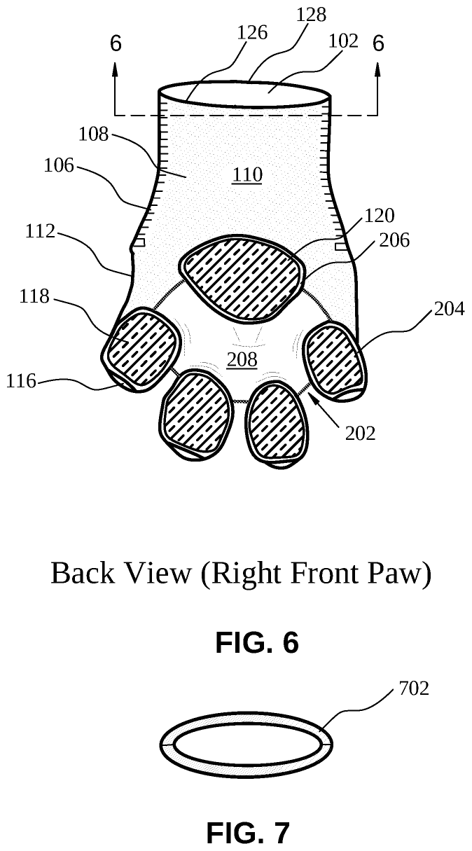

Referring to FIG. 6, there illustrated is a back side view of a boot cover and paw digits of the right front boot according to an embodiment of the present invention. As shown, the slits 104 are located in either side of the boot cover, extending form the top opening 102 of the upper tubular section downward. The digital paw grip pads 118 are attached to the bottoms of the sole layer sections 204 underneath individual paw digits 114. The metacarpal paw grip pad 120 is attached to the bottom of the sole layer section 206 located at bottom of the heel of the boot.

Referring to FIG. 7, there illustrated is a sectional view taken across line 6-6 of an upper tubular section 108 in FIG. 6. As shown in FIG. 7, the boot cover 110 is composed of a single layer 702. The single layer 702 of the boot cover 110, the inner layers of the paw digits 114, and the inner layer of the sole layer 202 may be made of a same flexible cloth with fibrous texture.

Minor changes may be expected within the scope of the present patent application. For example, in another embodiment, the boot cover 110 may comprise a liner layer in additional to the single layer 702. The inner layers of the paw digits 114 and the inner layer of the sole layer 202 may also comprise a liner layer in additional to the single inner layer. Although the embodiment of the present invention relates to a dog boot, schematic structures and parts for making may apply to boots for other small animals whose feet have commonalities with dog foot structure.

What is claimed is:

1. A dog boot comprising:
a. a boot cover, the cover including an upper tubular section, wherein the upper tubular section includes one or more slits, the slit extending from a top opening of the upper tubular section downward to divide the tubular section into two upper half sections for a dog's paw to slide into the boot easily, and a fastening means to secure the two upper half sections for wrapping around a leg of the dog;
b. a plurality of paw digits configured to receive each of dog toes, wherein each of the paw digits is coupled to the boot cover separately, the paw digits being not adjoining with one another along their sides so that the paw digits are movable relative to one another, and wherein a front of each of the paw digits is open for a toe nail of the dog to protrude; and
c. a sole, the sole including a sole layer and multiple paw grip pads, each of the paw grip pads being attached to a bottom location of the sole layer separately, wherein the sole layer is coupled to the boot cover and to the paw digits, forming a paw receiving space between the boot cover and the sole layer and between each of the paw digits and the sole layer, the paw receiving space is configured to form-fit the dog's paw, and the sole layer is curved such that the sole is configured to coordinate with bottom of a dog's paw, and wherein the paw grip pads include a plurality of digital paw grip pads and a metacarpal paw grip pad.

2. The dog boot of claim 1, wherein a hole is located in the boot cover for exposing a due claw of the dog.

3. The dog boot of claim 1, wherein each of the paw digits has a corresponding paw grip pad attached directly underneath thereof, and wherein the metacarpal paw grip pad is attached underneath bottom of a heel of the boot.

4. The dog boot of claim 1, wherein the paw grip pads have a rugged bottom.

5. The dog boot of claim 1, wherein the sole layer comprises multiple layers, the layers including an inner layer and an outer layer.

6. The dog boot of claim 5, wherein the paw digit comprises multiple layers, the layers including an inner layer and an outer layer.

7. The dog boot of claim 6, wherein the boot cover, the inner layer of the sole layer, and the inner layers of the paw digits are made of a flexible cloth or fibrous material.

8. The dog boot of claim 6, wherein the boot cover, the inner layer of the sole layer, and the inner layers of the paw digits are an integral piece of knitted yarns.

9. The dog boot of claim 5, the material for the outer layer of the sole layer is waterproof.

10. The dog boot of claim 6, the material for the outer layers of the paw digits is waterproof.

11. The dog boot of claim 1, wherein the paw grip pads are made of a rubbery material, the rubbery material being selected from a group including nitrile rubber, natural rubber, synthetic rubber, bicycle tire materials, and industrial tire materials.

12. The dog boot of claim 1, wherein the fastening means is selected from zipper, hook, or a sticky back and loop fastener (Velcro).

13. The dog boot of claim 10, wherein the hook and the sticky back and loop fastener are waterproof.

14. An animal boot comprising:
a. a boot cover, the cover including an upper tubular section, wherein the upper tubular section includes one or more slits, the slit extending from a top opening of the tubular section downward to divide the upper tubular section into two upper half sections for an animal paw to slide into the boot easily, and a fastening means to secure the two upper half sections for wrapping around a leg of the animal;
b. a plurality of paw digits configured to receive each of animal toes, wherein each of the paw digits is coupled to the boot cover separately, the paw digits being not adjoining with one another along their sides so that the paw digits are movable relative to one another, and wherein a front of each of the paw digits is open for a toe nail of the animal to protrude; and
c. a sole, the sole including a sole layer and multiple paw grip pads, each of the paw grip pads being attached to a bottom location of the sole layer separately, wherein the sole layer is coupled to the boot cover and to the paw digits, forming a paw receiving space between the boot cover and the sole layer and between each of the paw digits and the sole layer, the paw receiving space is configured to form-fit the dog's paw, and the sole layer is curved such that the sole is configured to coordinate with bottom of a dog's paw, and wherein the paw grip pads include a plurality of digital paw grip pads and a metacarpal paw grip pad.

15. The animal boot of claim 14, wherein each of the paw digits has a corresponding paw grip pad attached directly underneath thereof, and wherein the metacarpal paw grip pad is attached underneath bottom of a heel of the boot.

16. The animal boot of claim 14, wherein the paw grip pads have a rugged bottom.

17. The animal boot of claim 14, wherein the sole comprises multiple layers, the layers including an inner layer and an outer layer.

18. The animal boot of claim 17, wherein the paw digit comprises multiple layers, the layers including an inner layer and an outer layer.

19. The animal boot of claim 18, wherein the boot cover, the inner layer of the sole layer, and the inner layers of the paw digits are made of a flexible cloth or fibrous material.

20. The animal boot of claim 18, wherein the boot cover, the inner layer of the sole layer, and the inner layers of the paw digits are an integral piece of knitted yarns.

21. The animal boot of claim 18, the materials for the outer layer of the sole layer and for the outer layers of the paw digits are waterproof.

22. The animal boot of claim 14, wherein the paw grip pads are made of a rubbery material, the rubbery material being selected from a group including nitrile rubber, natural rubber, synthetic rubber, bicycle tire materials, and industrial tire materials.

23. The animal boot of claim 14, wherein the fastening means is selected from zipper, hook, or sticky back and loop fastener (Velcro).

24. The animal boot of claim 23, wherein the hook, and the sticky back and loop fastener are waterproof.
